(19) United States
(12) Patent Application Publication
(10) Pub. No.: US 2015/0379276 A1
(43) Pub. Date: Dec. 31, 2015

(54) SYSTEM ON A CHIP, CONTROLLER AND METHOD FOR SECURING DATA

(71) Applicants: ERAN GLICKMAN, RISHON LE ZION (IL); NIR ATZMON, NETANYA (IL); RON-MICHAELO BAR, RAMAT-HASHARON (IL)

(72) Inventors: ERAN GLICKMAN, RISHON LE ZION (IL); NIR ATZMON, NETANYA (IL); RON-MICHAELO BAR, RAMAT-HASHARON (IL)

(73) Assignee: FREESCALE SEMICONDUCTOR, INC., Austin, TX (US)

(21) Appl. No.: 14/316,884

(22) Filed: Jun. 27, 2014

(51) Int. Cl. G06F 21/60; H04L 9/08

(52) U.S. Cl. CPC G06F 21/602; H04L 9/0816; H04L 2209/24

(57) ABSTRACT

A system on a chip for securing data is described. The system on a chip comprises: a controller arranged to: partition a data block into a plurality of segments; and determine and extract a subset of the plurality of segments to be compressed. A compressor logic circuit is arranged to receive and compress the subset of the plurality of segments. The controller is arranged to retrieve the compressed subset of the plurality of segments from the compressor logic circuit and attach the compressed subset of the plurality of segments to a remainder of the partitioned data block for transmission.

### FIELD OF THE INVENTION

The field of this invention relates to a system on a chip, controller and method for securing data, and in particular to securing data against a security breach by striping portions of the data to be compressed and secured.

### BACKGROUND OF THE INVENTION

The use of data compression followed by data encryption is a known process designed to increase the strength of the data encryption process. Data compression techniques remove redundant character strings in data segments, which means that a compressed data segment has a more uniform distribution of characters. Data compression techniques also provide a shorter data segment, which reduces the amount of time needed to encrypt and decrypt compressed data segments.

Referring to FIG. 1, taken from US patent application publication number US 2010/0131040, a known storage system 100 is illustrated, comprising a number of storage devices 102, 104, 106, storage interface 108, data segmenter and/or data reassembler 110, segment compress and/or segment decompress 112, segment encrypter and/or segment decrypter 114 and interface 122, which is coupled to network 124.

User 128 is able to request, via user interface 126, that a file, data stream, or data block is to be stored. The file, data stream, or data block is passed via the storage interface 108 to the data segmenter and/or data reassemble 110, which breaks the file, data stream or data block into segments. The segment compress and/or segment decompress 112 compresses the segments, and segment encrypter and/or segment decrypter 114 encrypts the compressed segment(s).

The need to secure data against security breach attempts means that almost every system on a chip (SoC) employs security measures like those detailed above.

A SoC is usually centred on a central coherency fabric, and the ability to move data traffic through this central fabric is a significant measure of the SoC's performance. Therefore, the applications performed by the SoC must take into account this potential bottleneck, and try to avoid transporting unnecessary data traffic comprising large chunks of data on this central coherency fabric.

An issue with utilising compression and encryption to secure data is that the use of compression on large chunks of data or configuration data that is being processed by cores within the SoC need to also be encrypted. However, the added security comes at the expense of performance and added hardware resources (e.g. buffering etc.) to handle the combined process.

### SUMMARY OF THE INVENTION

The present invention provides a system on a chip, controller and method for securing data as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a known storage system that utilises compression and encryption to secure data.

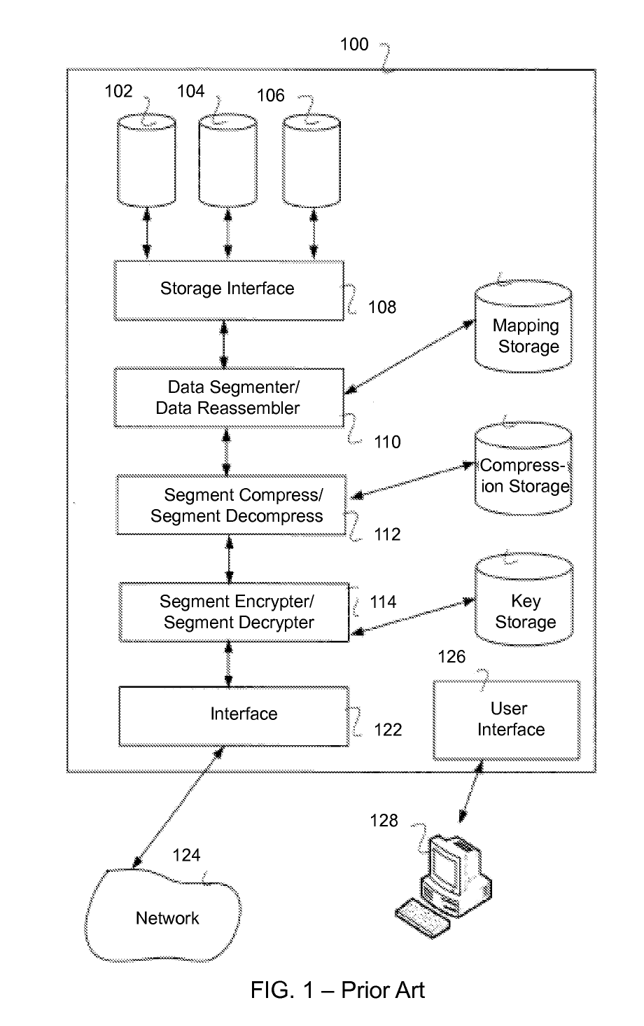

FIG. 2 schematically shows an example of a system on a chip (SoC).

FIG. 3 illustrates an example operation of a SoC.

FIG. 4 illustrates a block diagram of a stripe compress controller (SCC).

FIG. 5 illustrates a flow chart of an operation of an SCC during an encryption operation.

FIG. 6 illustrates a flow chart of an operation of an SCC during a decryption operation.

### DETAILED DESCRIPTION

Because the illustrated embodiments of the present invention may for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

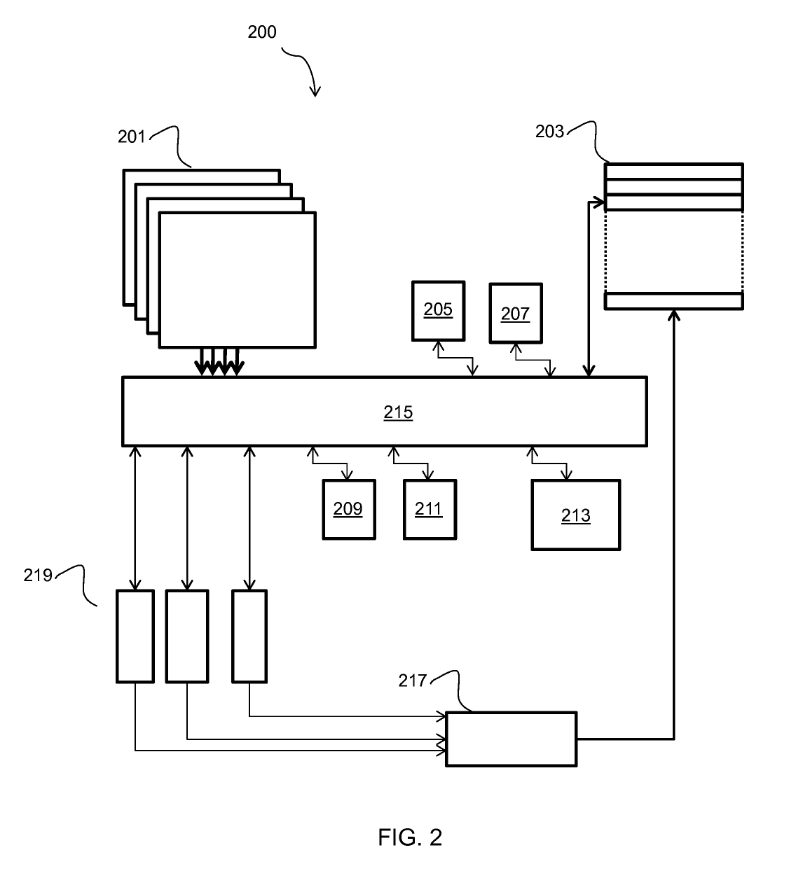

Referring to FIG. 2, a system on a chip layout 200 is illustrated, according to aspects of the invention. In this example, SoC 200 comprises, a number of cores 201, memory 203, compression logic circuit (sometimes referred to as compression engine) 205, encryption engine 207, key generator 209, secure local storage 211, and controller (or in some examples a processor) 213, wherein the above mentioned logic circuits and/or components are operably coupled to each other via a central coherency fabric 215. In some examples, the cores 201 may be general purpose cores or proprietary ones. One role of the cores 201 is to run code aimed at implementing additional or a higher degree of processing than is available from the hardware accelerators, such as key generator 209, controller 213, etc. In some examples, memory 203 may be a general purpose memory that is connected either internally or externally to the SoC 200 and used to store all data and computation results generated by the SoC 200. In network processors the hardware accelerators usually perform communication oriented tasks, such as communication protocol implementation, data encryption, etc. The cores 201 take the results from these hardware accelerators residing in memory 203 and transform the results into a user application. For example, upon sending an encrypted email, you press send, one of the number of cores 201 sends the mail to be encrypted in an encryption engine, then takes the results from memory 203 and sends it to, say, an ethernet mac application, etc. The nature of the SoC 200 is determined mostly by the hardware accelerators connected to the central coherency fabric 215. Although examples of the invention are described with regard to the SoC 200 being a networking SoC, other examples of the invention may employ the SoC in other applications, such as signal processing, video accelerators, etc.

In this example, in order to allow a fast and non-intrusive way to debug the hardware accelerators (e.g. key generator 209, controller 213, or further modules 219, etc.) and cores 201, a separate debug network 217 is built connecting all elements of the SoC and capable of reading, upon request, debug information and writing it out to a debugging equipment. In some examples, the debug network may use standard protocols or be proprietary in nature.

In this example, the controller 213 may be operable to interleave (otherwise referred to as stripe) segments of data from a data sequence. For example, the controller 213 may be operable to stripe some or all of the data sequence, wherein the stripe pattern may be based on a secure key (potentially a randomly generated key) generated from random key generator 209. Therefore, in some examples, the controller 213 may be considered as a stripe compress controller (SCC).

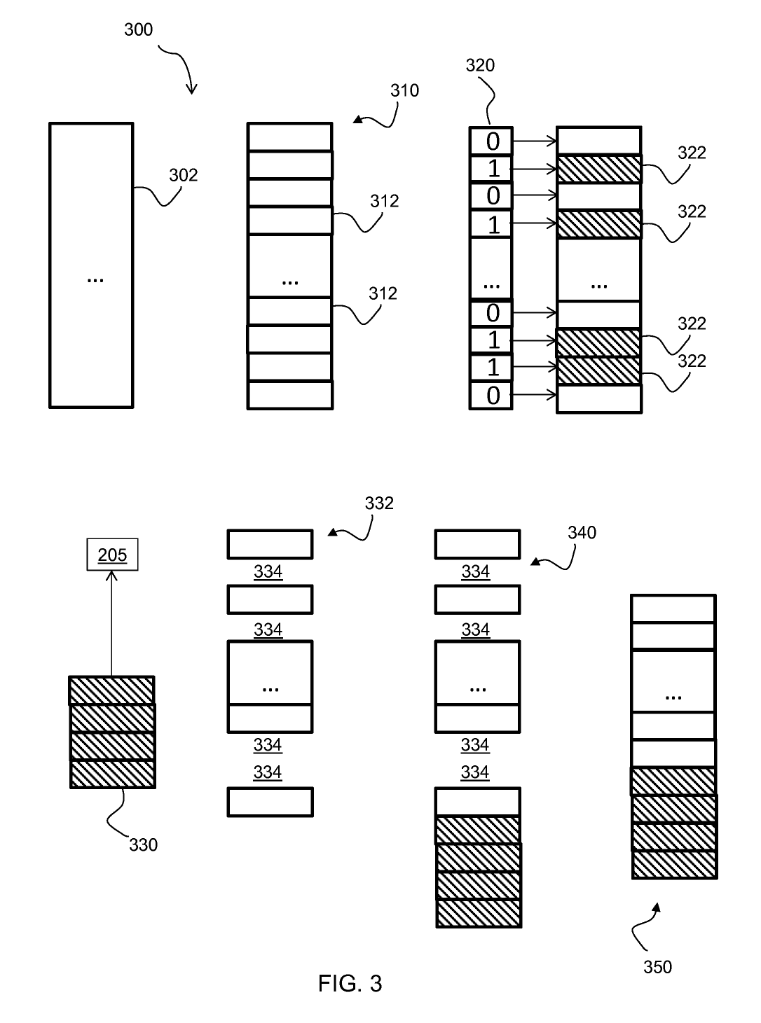

Initially, the controller 213 may be programmed by a user with information pertaining to the location of data to be secured, for example within secure local storage 211, which may comprise a start and an end address of the data to be secured or a start address and size. Further, in order to create a random striping pattern the SCC needs to create a random striping seed (as illustrated and described later with reference to FIG. 3). In some examples, the random striping seed needs to be secure and unrecoverable by any third party. In some examples, the random striping seed may be provided by the user via software routed over an interface (not shown) or via any other source that is external to the SoC. In one example embodiment of the invention, the random striping seed may be provided internally and securely by the (independent) random key generator 209. In a yet further example, a secure random key that is already present in the SoC for other encryption work may be utilized for the striping. Thus, in some examples, the key may be based on one of: a user defined key, a secure key, a key generated by a random key generator coupled to the controller or indeed any manipulation of any of the above options. In some examples, the user may provide information to the controller 213 relating to a source of a random striping seed that is to be utilised according to the system's security requirements.

In this example, the controller 213 may locate the data to be secured from the secure local storage 211 and partition the data into stripes according to: the key provided by the user, or a key generated from random key generator 209, or a secure random key already present in the SoC utilized for encryption. In other example embodiments of the invention, it is also envisaged that the SCC may create a new seed, for example based on manipulation of keys from one, multiple or all sources.

In some examples, the key provided may be 512 bits in size and, therefore, the located data may also be partitioned into 512 sections and/or stripes. In some other examples, the size of the key provided may only be limited by user requirements and the capability of the system utilising aspects of the invention. Therefore, in some examples, the amount of striping may change, and may be dependent on the bandwidth of the currently system. As a result, a managing core of the SoC may be responsible for managing the amount and size of striping in the system.

After the controller 213 has partitioned the data, the controller 213 may apply the obtained random striping seed in order to randomly determine a number of the partitions that are to be compressed. For example, a portion of the random striping seed may comprise the following sequence 100100001, wherein a ‘1’ denotes compression, and a ‘0’ denotes no compression. Therefore, partitions corresponding to the ‘1’ values may be separated by the controller 213 and aggregated together to form a further block of data comprising data that is marked as to be compressed. In some examples, the controller 213 may determine a number of randomly generated stripes to be aggregated based on a capability of the compression engine 205.

Subsequently, if at least one block of data to be compressed has been aggregated by the controller 213, the controller 213 may transmit this block to the compression engine 205 to be compressed, before writing the block to, say, a temporary location inside local storage, for example secure local storage 211 (e.g. secure memory). Furthermore the random striping seed used for the striping process may be added to a location known to the SCC. In some examples, the location of the random striping seed may be added to the beginning, end or indeed any other location within the code. The seed is added and not compressed since it is unknown which portions to decompress prior to its retrieval.

After the compression engine 205 has completed its compression operation, the controller 213 may fetch and position the compressed block of data, say, at either the beginning or the end of the original partitioned, striped, data block.

It should be noted that the original partitioned data block now comprises the original uncompressed data, which was not marked for compression by the random striping seed. The original partitioned data block now also comprises empty partitions where data marked to be compressed was moved and aggregated by the controller 213 into a block to be compressed, and the block of compressed data is positioned at either the beginning or end of the original data block. Therefore, in some examples, the controller 213 may be operable to determine partitions to be compressed, based on a random striping seed, and reposition, or scramble, the position of the compressed partitions relative to their positions in the original data block.

Subsequently, the data block may be transmitted by the controller 213 to the encryption engine 207, which encrypts based on different keys.

In order to facilitate effective decompression the location of the compressed data inside the entire data block must be known to the SCC creating the original message. If the compressed data is not added to the beginning or end of the newly created data ready for encryption, but rather to a random location in the newly created data, the ‘offset’ of this data may also be stored in a known location within the code in order to facilitate effective decompression.

In some examples, decryption may subsequently follow a reverse process to the aforementioned encryption and compression process. Therefore, the same or a further controller (not shown) may initially retrieve the utilised random striping seed provided from the user and embedded in the code. In these examples, and using this random striping seed, the decrypting SCC will know which portions of data needs decompression after the decryption process and where to leave holes in the memory to insert the decompressed data to receive a complete message.

A resultant decrypted data block may equate to the previously compressed data block, comprising for example uncompressed data partitions, empty data partitions, and a block of compressed data at the beginning or end of the data block. In some examples, after the random striping seed is retrieved and data decrypted, the seed may be used in order to allow decompression and repositioning of the blocks of compressed data, wherein the random striping seed may only be available to the controller 213 and/or any potential further controller. In some examples, the random striping seed is available since its location is known to the SCC by the user and/or it may be in a fixed location.

In some examples, if a security breach is detected, knowledge and/or location of the random striping seed and/or provided key by the user or key generator 209 may be deleted to prevent decompression and/or decryption of data. Therefore, in some examples, a two tier security system may be implemented, comprising a failsafe mode in case of a security breach.

Examples of a security breach could be an unauthorised user attempting to access a ‘debug mode’ of the device, or an unauthorised user attempting to access a secure part of the device. In these examples, the security breaches could be detected by utilising specialist sensors that may monitor the device, for example SoC 200.

An advantage of striping a portion of the total data to be compressed, for example randomly, may allow a two tier security system to be implemented without requiring the SoC 200 to process large chunks of data. Therefore, increased security can be provided without a significant increase in processing power or reduction in SoC 200 performance, due for example to the central fabric 215 handling smaller chunks of data when compared to similar systems in the art.

Furthermore, and in some examples, scrambling the data marked to be compressed by rearranging and/or grouping it into a single block may further enhance security and may add a further tier of security. For example, portions of data may not only have been compressed and encrypted, but the position of the compressed data blocks may have been scrambled and/or re-arranged by the controller 213. Therefore, in some examples, the aspect of rearranging data to be compressed may be seen as a further tier of security, without incurring a significant increase in processing power or reduction in performance of the SoC 200.

In some examples, some aspects of the invention may be implemented in a Layerscape™ architecture, which combines the extreme performance of today's most capable communications processors with the familiar, modular, high-level programming models used worldwide.

In some examples, the concepts herein described may be implemented in architectures containing cores 201 running general purpose software or proprietary software. In some examples, the cores 201 themselves may also be proprietary containing proprietary features. The cores 201 are connected to a central coherency fabric 215 that keeps the data, to and from the cores 201, coherent so that multiple cores 201 can handle the same task. The central coherency fabric 215 hardware accelerators, e.g. key generator 209, controller 213, or further modules 219, etc., are connected in order to perform specific tasks and may be used to offload tasks from the cores 201. In this manner, a better use of the available computing power may be achieved. In some examples, these hardware accelerators may be specifically designed to efficiently perform their tasks, and may comprise special hardware to assist in this regard. Depending upon the nature of the hardware accelerators, the cores 201 used and their respective performance, the nature of the SoC 200 may be determined. For example, if the SoC 200 has powerful general purpose cores 201, digital signaling cores, digital signaling accelerators and image coding and decoding accelerator, the SoC 200 may be configured as, say, a digital image processor. Alternatively, for example, if the SoC 200 has communication protocol accelerators, data management accelerators, etc., the SoC 200 may be configured as, say, a networking processor. In some examples, the software used in the SoC 200 may be tailor made for networking, in that it may be used to activate the various hardware accelerators in such a way as to construct a stream of data traffic that complies to networking protocols. In this manner, by use of the SoC 200 configured as, say, a networking processor allow high-bandwidth traffic may be supported, which could not otherwise be supported using general purpose cores since they would need to run significant amounts of code with high line rates per port and relatively low power.

In some examples, the controller 213 may be operable to separate, in some examples randomly separate, the position of the compressed data throughout the originally partitioned data block, rather than positioning the compressed data at the beginning or end of the original partitioned data block. This may have an advantage of further increasing security and resilience to hacking. Further, on detection of a breach, the controller 213 may be operable to delete portions of the compressed data.

In some examples, the keys utilised in the compression procedure may be randomly inserted within the original data block.

Therefore, some examples of the invention may be operable to provide a system that is capable of varying the level of protection and/or security, thereby allowing a user to determine a trade-off between additional security and performance.

In some examples, a user may be able to tailor the protection and/or security conferred from the system, for example by choosing between a fully compress and/or encrypt combination, a partial compress and/or encrypt combination, or a no compress and/or encrypt at all mode of operation, depending on system requirements. Further, in some examples, the user may be operable to selectively utilise scrambling of compressed data in one or more of the above user definable combinations of protection and/or security.

Referring to FIG. 3, an example operation of the SoC 200 from FIG. 2 is illustrated utilising segments of data blocks 300. Initially, a controller, for example the controller 213 of FIG. 2, may be made aware of a location of data block 302 via, for example, a beginning and end address of the data block.

Subsequently, the controller may partition the data block 302 into stripes based on a key provided by a user or key generated from a key generator, for example key generator 209 of FIG. 2. In this example, the key may be 512 bits in size and, therefore, the controller may stripe the data block 302 based on the key, resulting in striped block 310, comprising, in this example, 512 striped blocks 312. The actual key used for the striping process is referred to as the random striping seed. In some examples, the random striping seed may be similar to the key provided by the user or a key generated by the random key generator 209, or indeed based on a manipulation of either of said keys.

The controller may subsequently mark data to be compressed based on a striping seed, which in this example may be a random striping seed 320. Therefore, based on random striping seed 320, wherein a ‘1’ denotes data stripes to be compressed and a ‘0’ denoted data stripes to be left unchanged, corresponding data stripes 322 may be marked for compression.

The controller may aggregate stripes to be compressed 322 together, as shown by 330, and transmit to a compression engine, for example compression engine 205 of FIG. 2. As a result, the resultant striped data block 332 may now comprise holes 334 in the data block where marked stripes for compression 322 were situated.

Subsequently, the controller may, after block 330 has been compressed, position this block at the beginning or end of resultant data block 332. Therefore, prior to encryption, the controller 213 may scramble the data block to result in, for example, scrambled data block 340. In some examples, the compressed block 330 may be placed at a random location embedded inside the data block that may be identified with an ‘offset’ value, and not just located at the beginning or end of resultant data block 332, thereby further increasing a scramble factor and increasing the security. However, in this example, the offset may be embedded in a known location, to facilitate effective decompression.

Thereafter, the controller may transmit the scrambled data block 340 to an encryption engine, for example encryption engine 207 of FIG. 2, wherein a resultant encrypted data block 350 may be output, with at least holes 334 removed.

Therefore, in some examples, a three-stage security procedure in order to protect data block 302 may be implemented comprising, selective compression of stripes, scrambling of the compressed stripes, and encryption of the resultant data block.

One advantage of the above mentioned examples may be that a more secure data protection system can be provided, without impacting on performance of a SoC, for example SoC 200, as smaller blocks for compression may be transmitted via the central fabric 215 compared to current systems. Further, by repositioning stripes that have been marked for compression into a group to be positioned at the beginning or end of a block of data, security has been further enhanced compared to current systems.

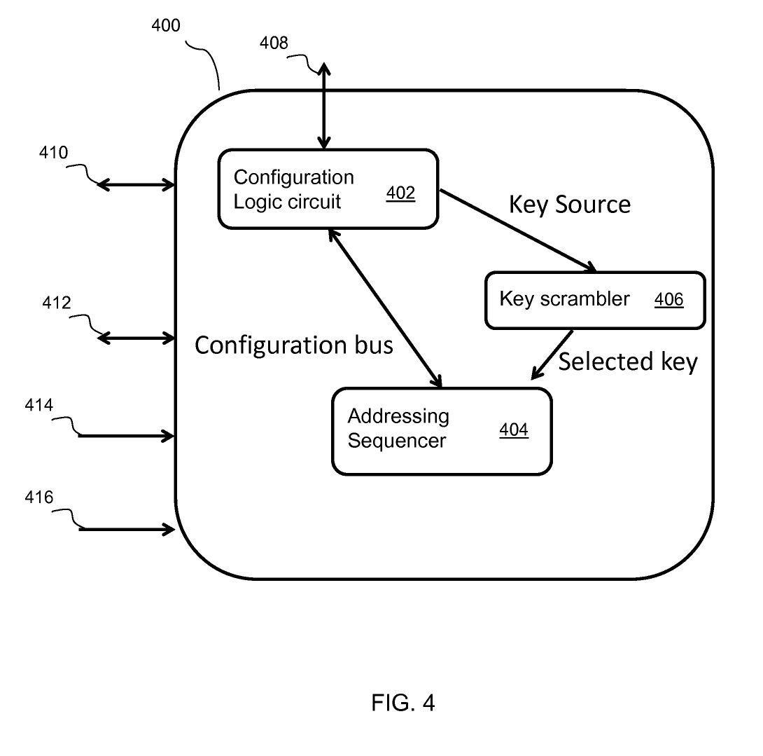

Referring to FIG. 4, an example block diagram of a stripe compress controller 400, for example controller 213 of FIG. 2, is illustrated, according to aspects of the invention. Stripe compress controller 400 comprises: a host interface 408 arranged to operably couple external modules and/or components to a configuration logic circuit 402. In this example, the configuration logic circuit 402 may be operable to contain user programmed information, for example addresses, sources of keys, and a command register operable to instruct the SCC 400 to protect or extract data.

If the data received at the configuration logic circuit 402 is to be scrambled, the configuration logic circuit 402 sends a key source to a key scrambler logic circuit 406. In this example, the key scrambler logic circuit 406 then sends a selected key to addressing sequencer logic circuit 404, so that the selected key can be used by the addressing sequencer logic circuit 404 in communication of the (scrambled) data with the configuration logic circuit 402.

Further, the SCC 400 comprises a number of further input/outputs, namely compress interface 410, encrypt interface 412, key 414, violation 416, and a number of bus controllers (not shown) arranged to provide the SCC 400 with one or more of, for example: compressed data, encrypted data, keys, error messages, etc.

Further, in some examples, the addressing sequencer 404 may be operable to hold state machines and may comprise temporary storage, for example for storing configuration data in order to allow manipulation of data, sequencing of flows, and activation of various interfaces.

The addressing sequencer 404 may further be operable to ‘zero out’ a section of data where the random striping seed resides, for example at the beginning of the compressed block of data, should a violation be detected. Therefore, ‘zeroing out’ information regarding the random striping seed, for example overwriting with zeros, may add a yet further layer and/or tier of security. In some examples, the addressing sequencer 404 may write, for example, ‘00000’ to the seed location, if a breach is detected. In some examples, if the compressed block is located using an offset, this offset may also be zeroed.

In some examples, the key scrambler logic circuit 406 may be operable to determine a key from various sources, for example user programmed sources, random key generator, for example key generator 209 of FIG. 2, or a secure key. Further, the key scrambler logic circuit 406 may be operable to scramble data if a secure key is selected.

The SCC 400 is further operable to communicate with various other logic circuits within a SoC, for example SoC 200, via for example control fabric 215.

In some examples, some or all of the operation of the SCC 400 discussed above may be implemented in software, rather than in a hardware logic circuit. Furthermore, the communications interfaces of the stripe compress controller 400 may be used to allow software and data to be transferred between stripe compress controller 400 and external devices. Examples of communications interface may include a modem, a network interface (such as an Ethernet or other NIC card), a communications port (such as for example, a universal serial bus (USB) port), a PCMCIA slot and card, etc. Software and data transferred via such communications interfaces may be in the form of signals which can be electronic, electromagnetic, and optical or other signals capable of being received over a communication channel by a communications interface.

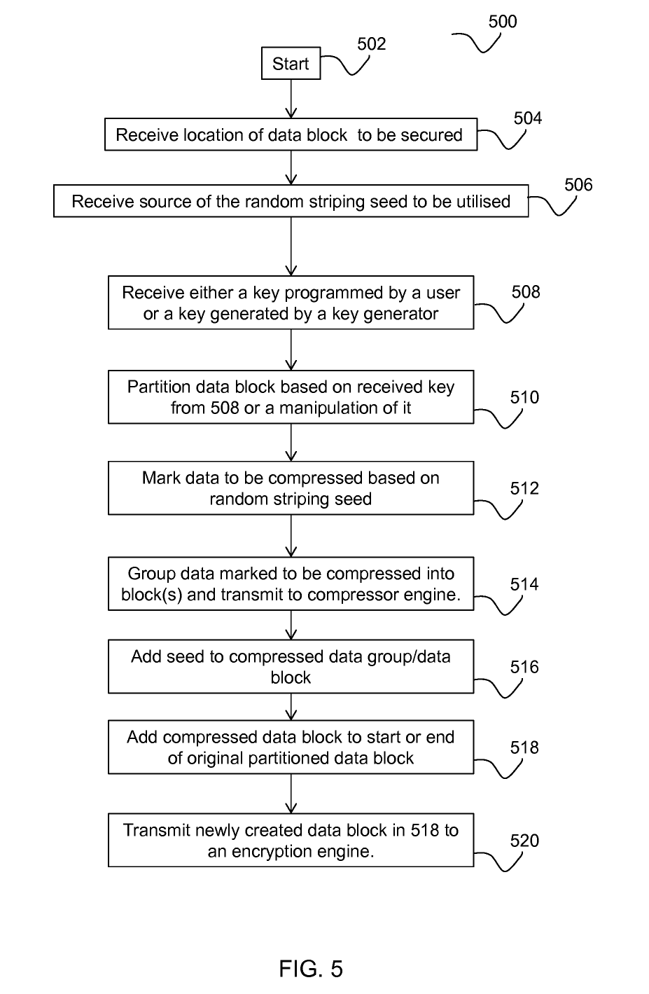

Referring now to FIG. 5, an example flow chart of an operation of a stripe compress controller during an encryption operation is illustrated, according to some aspects of the invention. Initially, at 502, the operation of the SCC commences and, at 504, the SCC may receive location information regarding a location of a data block to be secured. In some examples, the location information may comprise at least a start address and an end address of at least one data block to be secured. In some other examples, data to be transmitted may be written to an external memory, and subsequently read into an internal memory by the SCC, prior to the SCC beginning a stripe operation.

Further, the SCC may receive, at 506, a source of a random striping seed to be utilised. At 508, the SCC may also receive either a key that is programmed by a user or a key that is generated by a key generator, thereby allowing the SCC to determine, for example, a number of stripes required for the located data block. Thus, this key, or a manipulation thereof, may comprise the random striping seed.

At 510, the SCC may partition the located data block based on a size of the key from 508. For example, if the key is 300 bits in size, the data block may be striped into 300 sections and/or stripes.

Subsequently, at 512, the SCC may refer to the random striping seed and mark a random number of stripes of the partitioned data block to be compressed. In some examples, the amount of sections/stripes to be compressed may always be less than the total amount of stripes partitioned in the data block.

At 514, the SCC may re-arrange and/or group the sections and/or stripes of the data block to be compressed before the group is transmitted to a compressor engine. In some examples, the SCC may determine the size of the group(s) of data to be compressed, for example based on the capability of the compressor engine. After the group(s) of data to be compressed has been sent to the compressor engine, it may also be written into a temporary location inside local storage.

At 516, the key utilised to partition the data block may be added to the first block of compressed data. In some other examples, the key utilised to partition the data block may be randomly inserted into the data block. At 518, the SCC may retrieve the now compressed group/block of data and position it at the start or end of the original partitioned data block from 510.

In some other examples, the SCC may randomly separate and position the compressed group/block throughout the original partitioned data block from 510. This may have an advantage of further increasing complexity of the compression and/or encryption procedure, resulting in higher security.

Further, in some examples, on detection of a breach, the SCC may be operable to delete random portions of the compressed data and random striping seed. An effect of this operation may be that the data marked for compression in 512 has additionally been scrambled, leading to a yet further level of security.

At 520, the SCC may transmit the data block from 518 to an encryption engine, which may be operable to encrypt the data block by at least, for example, removing any holes created by grouping sections and/or stripes for compression.

In some examples, if a breach is detected, the SCC may remove information regarding the location of keys that are required for compression, for example the location of the random striping seed and the key provided by a user or key generated from a key generator.

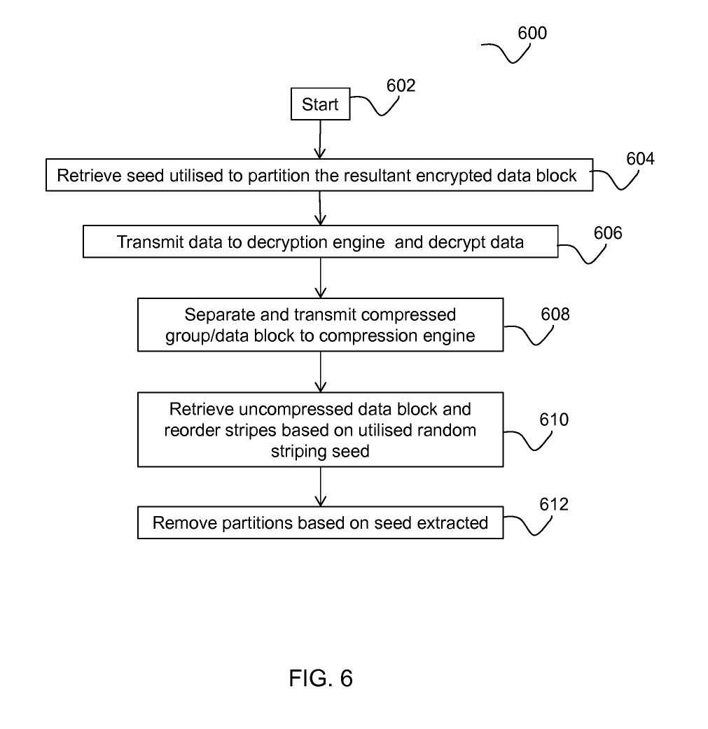

Referring now to FIG. 6, an example flow chart 600 of an operation of a stripe compress controller during a decryption operation is illustrated, according to some aspects of the invention. Initially, at 602, the operation commences and, at 604, the SCC retrieves the random striping seed that is utilised to partition the data block, which in this example may be positioned at the first block of the compressed data.

At 606, the SCC may transmit the data to a decryption engine, wherein the decryption engine may write the decrypted data back according to the key, thereby recreating at least the correct positions of the holes due to compression.

At 608, the SCC may further separate and transmit the compressed group/data block to a compression engine to be decompressed. At 610, the SCC retrieves the decompressed data and re-orders the stripes according to the utilised random striping seed, thereby reconstructing the original data block prior to compression. At 612, the SCC may remove partitions based on the key provided by the user or key generator.

Those skilled in the art will recognize that the boundaries between logic or functional blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A system on a chip for securing data, the system on a chip comprising:
a controller arranged to:
partition a data block into a plurality of segments; and
determine and extract a subset of the plurality of segments to be compressed; and
a compressor logic circuit arranged to:
receive and compress the subset of the plurality of segments;
wherein the controller is arranged to retrieve the compressed subset of the plurality of segments from the compressor logic circuit and attach the compressed subset of the plurality of segments to a remainder of the partitioned data block for transmission.

2. The system on a chip of claim 1, wherein the controller is arranged to use a random striping seed in order to randomly determine a number of the partitioned data segments that are to be compressed.

3. The system on a chip of claim 1, wherein the controller is further arranged to detect a security breach and in response thereto implement a security breach measure.

4. The system on a chip of claim 3, wherein in response to the controller detecting a security breach, the security breach measure comprises the controller being further arranged to delete at least one of: knowledge of a random striping seed, a location of a random striping seed.

5. The system on a chip of claim 2, wherein the controller is arranged to scramble a location of the compressed partitioned data segments in the data block relative to their positions in an original data block.

6. The system on a chip of claim 5, wherein the random striping seed is variable to change an amount of striping dependent on an operational bandwidth of the system.

7. The system on a chip of claim 1, further comprising an encryption logic circuit arranged to receive and encrypt the transmitted data block with the attached compressed subset of the plurality of segments.

8. The system on a chip of claim 1, wherein the controller is arranged to attach the compressed subset of the plurality of segments to at least one of: a beginning of the partitioned data block for transmission, an end of the partitioned data block for transmission, a random location in the partitioned data block for transmission identified by an offset wherein the offset is stored in a known location in the code to facilitate decompression.

9. The system on a chip of claim 1, wherein the controller is operably coupled via a control fabric to at least one of: at least one core, at least one peripheral, at least one memory, a key generator 209, a secure memory.

10. The system on a chip of claim 1, wherein the data block is partitioned according to a key.

11. The system on a chip of claim 10, wherein the controller is arranged to partition located data block based on a size of the key.

12. The system on a chip of claim 10, wherein the key is located within the data block transmitted to an encryption logic circuit.

13. The system on a chip of claim 10, wherein the key is deleted upon a security breach being detected, thereby preventing decompression of the partitioned data block.

14. The system on a chip of claim 10, wherein the key is based on one of: a user defined key, a secure key, a key generated by a random key generator coupled to the controller.

15. The system on a chip of claim 1, wherein the random key generator is arranged to determine for each of the plurality of segments whether it will compress the segment once that segment is read.

16. The system on a chip of claim 1, wherein the controller is arranged to extract a subset of the plurality of segments to be compressed and aggregate a plurality of segments of the subset to form a further block of data comprising data that is identified to be compressed.

17. The system on a chip of claim 1, further comprising a data storage operably coupled to the controller such that the controller is arranged to perform at least one of a group of:
transmit the compressed subset of the plurality of segments attached to the partitioned data block to the data storage,
be programmed with information on a location of data contained within the data storage that is to be secured.

18. A controller for securing data, the controller arranged to:
partition a data block into a plurality of segments; and
determine and extract a subset of the plurality of segments to be compressed; and
retrieve a compressed subset of the plurality of segments from a compressor logic circuit and attach the compressed subset of the plurality of segments to a remainder of the partitioned data block for transmission.

19. A method of securing data, comprising:
partitioning a data block into a plurality of segments;
determining and extracting a subset of the plurality of segments to be compressed;
receiving and compressing the subset of the plurality of segments;
retrieving the compressed subset of the plurality of segments; and
attaching the compressed subset of the plurality of segments to a remainder of the partitioned data block for transmission.

20. The method of securing data of claim 19, further comprising:
detecting a security breach; and in response thereto
implementing a security breach measure.
